(19) United States
(12) Patent Application Publication
(10) Pub. No.: US 2026/0353326 A1
(43) Pub. Date: Nov. 5, 2026

(54) CELL PHASE TIMING MISALIGNMENT HANDLING FOR AIR TO GROUND (ATG)

(71) Applicant: Apple Inc., Cupertino, CA (US)

(72) Inventors: Qiming Li, Beijing (CN); Jie Cui, San Jose, CA (US); Yang Tang, San Jose, CA (US); Manasa Raghavan, Sunnyvale, CA (US); Hong He, San Jose, CA (US); Xiang Chen, Palo Alto, CA (US); Yuexia Song, Beijing (CN); Haitong Sun, Saratoga, CA (US); Rolando E. Bettancourt Ortega, Munich (DE); Dawei Zhang, Saratoga, CA (US)

(21) Appl. No.: 19/111,819

(22) PCT Filed: Sep. 30, 2022
(86) PCT No.: PCT/CN2022/123278

§ 371 Date: Mar. 14, 2025

(51) Int. Cl. H04W 56/00; H04W 24/10; H04W 64/00; H04W 76/20; H04W 84/06

(52) U.S. Cl. CPC H04W 56/0045; H04W 24/10; H04W 56/001; H04W 64/00; H04W 76/20; H04W 84/06

(57) ABSTRACT

A user equipment (UE) can operate as an in-flight airplane communicatively coupled to air to ground (ATG) network. The UE can process an indication that enables or not enables a transmit timing difference between base stations on a same frequency carrier. A propagation delay difference between cells of base stations is based on a location of the UE and a base station location from an air to ground (ATG) network, based on a derivation according to a system frame number (SFN) and a timing difference (SFTD), or based on an indication by the ATG network. A total time difference can be determined based on the transmit timing difference and the propagation delay difference, and whether the total time difference satisfies a predefined threshold for determining the UE behavior for cell phase timing misalignment handling.

### FIELD

The present disclosure relates to wireless technology including cell phase timing misalignment handling for air to ground (ATG).

### BACKGROUND

Mobile communication in the next generation wireless communication system, 5G, or new radio (NR) network provides ubiquitous connectivity and access to information, as well as ability to share data, around the globe. 5G networks and network slicing is a unified, service-based framework that will target to meet versatile and sometimes, conflicting performance criteria to provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions. Another type of mobile communication includes vehicle communication, where vehicles communicate or exchange vehicle related information. The vehicle communication can include vehicle to everything (V2X) devices or a V2X user equipment (UE), which includes vehicle to vehicle (V2V), vehicle to infrastructure (V2I) and vehicle to pedestrian (V2P) where direct communication without a base station may be employed, such as in a sidelink (SL) communication.

Additionally in 3GPP, an air to ground (ATG) network refers to in-flight connectivity techniques, using ground-based cell towers dedicated to sending signals up to an aircraft's antenna(s) of an onboard ATG terminal. Some commercial or trial in-flight networks are based on hybrid techniques of ATG and satellite communication to provide in-flight service to passengers of airplanes in-flight. The satellite link focuses on providing every-where connectivity (e.g., when crossing the sea or ocean), while the ATG link focuses on providing high-quality data services for all service available areas (e.g., inland and coastline areas). Considering that ATG has the advantage of high throughput, low propagation delay, and low cost application, some operators and the aircraft industry demand the deployment of ATG, and there is an urgency to begin the standardization of ATG, especially for the coexistence of ATG and International Mobile Telecommunications (IMT), for example. In order to ensure seamlessness in wireless connectivity, aspects of signaling for cell phase misalignment among ATG networks and other networks (e.g., terrestrial networks (TN)) are further being considered.

### BRIEF DESCRIPTION OF THE DRAWINGS

FIG. 1 illustrates an exemplary block diagram illustrating an example of airplane user equipment(s) (UEs) communicatively coupled with base stations in connection with various embodiments (aspects) described herein.

FIG. 2 illustrates another exemplary block diagram illustrating an example of an airplane UE communicatively coupled with base stations in connection with various embodiments (aspects) described herein.

FIG. 3 another exemplary block diagram illustrating an example of an airplane UE communicatively coupled with base stations in connection with various embodiments (aspects) described herein.

FIG. 4 another exemplary block diagram illustrating an example of an airplane UE communicatively coupled with base stations in connection with various embodiments (aspects) described herein.

FIG. 5 exemplary block diagram illustrating an example of an airplane user equipment(s) (UEs) communicatively coupled with base stations in connection with various embodiments (aspects) described herein.

FIG. 6 exemplary block diagram illustrating an example of an airplane UE communicatively coupled with base stations in connection with various embodiments (aspects) described herein.

FIG. 7 illustrates block diagram illustrating an example of an airplane UE communicatively coupled with base stations in connection with various embodiments (aspects) described herein.

FIG. 8 illustrates an exemplary block diagram illustrating an example of UEs communicatively coupled a network with network components in connection with various embodiments (aspects) described herein.

FIG. 9 illustrates an example UE configuration for handing cell phase timing misalignment for communications in an air to ground (ATG) network according to various aspects.

FIG. 10 illustrates an example process flow of handling cell timing phase misalignment in an ATG network according to various aspects.

FIG. 11 illustrates an example process flow of handling cell timing phase misalignment in an ATG network according to various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects include a user equipment (UE) device or a base station configuring signaling to handle cell phase timing misalignment, especially for air to ground (ATG) networks with an in-flight airplane terminal operating as the UE for providing service (e.g., networking, Wifi, etc.) to passenger UEs. Legacy cell phase timing is mainly based on a cell transmit timing difference and a propagation delay difference, which can be specified according to the legacy terrestrial network deployment. However, being able to handle cell phase timing differences between different cell networks when the UE is an in-flight terminal, such as an airplane at very high speeds (e.g., up to 300 km/h or about 186 m/h) with a much larger coverage range (e.g., up to 1200 kilometers or 745 miles), can present various challenges. varying propagation time differentials along with larger round-trip times (RTT) can result in a greater likelihood of cell phase misalignment, especially between one type of network such as an ATG network and another network, which may be another ATG network as the target network or a different network with a different core dedication technology such as a terrestrial network (TN).

In-flight UE terminals such as airplanes can be configured as a customer premise equipment (CPE) terminal devices that dedicates services for enabling other user devices or UEs access to the internet through 5G signals from a 5G base station. The CPE UE or in-flight UE terminal transfers the 5G signals into WiFi signals or wired signals, and thus operates similarly as a small base station or router/mobile WiFi combination. As such, airlines offering in-flight WiFi service have a vested interest in ensuring quality and seamless service to their passengers as users of cell phones or other UEs. In order to ensure the proper handling of any cell phase timing misalignments with ground based base stations, signaling processes can be standardized for uniformity in maintaining the quality and seamless service. Considering that ATG has the advantage of high throughput, low propagation delay, and low cost application, some operators and the aircraft industry have made strong request for the deployment of ATG, and thus, there is a new urgency in demand to start the standardization of ATG, especially for those processes which are important for the coexistence of ATG and International Mobile Telecommunications (IMT).

In various aspects, an indication of a cell phase timing misalignment can be enhanced and the corresponding UE behavior clarified. For example, an indication can be configured to such as a derive synchronization signal block (SSB) index from cell indication (deriveSSB-IndexFromCell) to indicate a propagation delay difference and a base station transmit timing difference depending on whether this indication is enabled as true or not enabled as false. When the deriveSSB-IndexFromCell is enabled, the UE can assumes a frame boundary alignment (including half frame, subframe and slot boundary alignment) across cells on the same frequency carrier is within a tolerance not worse than a minimum of 2 SSB symbols or 1 physical downlink shared channel, min(2 SSB symbols, 1 PDSCH symbol), and system frame numbers (SFNs) of all cells on the same frequency carrier are the same. In ATG networks, when the indication is true an additional offset can be configured so that the target cell for measurement is offset by a propagation time difference between the serving cell and the target cell. In particular, this transmit timing difference when deriveSSB-IndexFromCell is enabled as true can be predefined. The propagation delay difference can be configured as an offset between cells on the same carriers as derived by the UE itself based on the UE's location and the network location, on the UE SFN and Frame Timing Difference (SFTD) measurement or indicated by the network to the UE when the UE reports its location.

Alternatively, or additionally, if the propagation time difference between a serving cell and a target cell is unknown, the indication (deriveSSB-IndexFromCell) could be disabled/not enabled/false. When false, the UE can treat the cells as asynchronous, and the UE performs an infra-frequency cell identification with an SSB index reading, in which the UE is indicated to report the SSB based Radio Resource Management (RRM) measurement result with the associated SSB index. In this context, unknown can mean that the UE location is unknown to the network if the network determines the propagation delay different, or the base station (e.g., gNB) location is unknown to the UE if the UE determines the propagation delay difference. Additionally, or alternatively, a scheduling restriction window for the UE can be configured as all symbols within a synchronization signal (SS)/physical broadcast channel (PBCH) measurement timing configuration (SMTC) window duration.

In another aspect, the UE can receive a network indication from the base station indicating whether the target network is a terrestrial network (TN) or an ATG network. When the target network is indicated as a TN network, the indication (deriveSSB-IndexFromCell) can be enabled for a UE reception timing difference, but when indicated as another ATG network, the indication can be enabled for the transmit timing difference or determine that the target cell is asynchronized.

Additionally, or alternatively, the transmit timing different can be indicated via different information element values. The network can indicate difference IEs for example with different cell phase timing misalignment values to the UE. The cell phase timing misalignment values can be used to determine a total time difference to the UE between the ATG network and the target network, if the UE location is known to the network, for example. These and other aspects are detailed below with reference to figures.

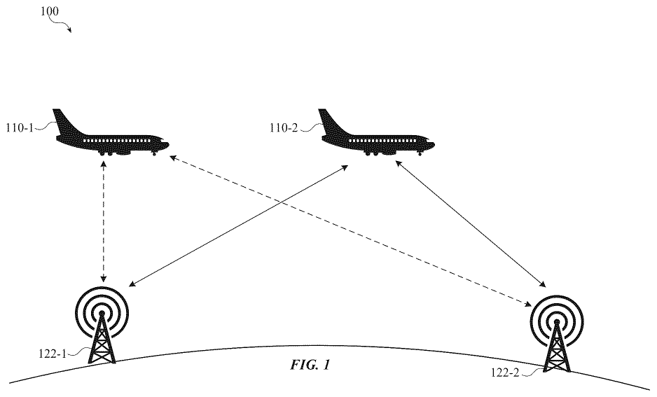

FIG. 1 is an example illustrating a wireless system 100 for air-to-ground (ATG) communications over an ATG network. UE 110-1 is communicatively coupled the ATG base station 122-1 (e.g., gNB, eNB, or the like) in coexistence with a target network of a target base station 122-2. An ATG network refers to in-flight connectivity technique, using ground-based cell towers that send signals up to an aircraft's antenna(s) of an onboard ATG terminal of the in-flight airplane as UE 110-1 or UE 110-2, for example. As the plane UE 110-1 or 110-2 travels into different sections of airspace, the onboard ATG terminal automatically connects to the cell or base station (e.g., 122-1, 122-2, etc.) with strongest received signal power, just as a mobile phone does on the ground. In this network, a direct radio link can be established between a base station (e.g., 122-1, 122-2, etc.) on the ground, referred to as a terrestrial network (TN) network and a customer premise equipment (CPE) type of UE mounted in the aircraft as UE 110-1 or 110-2, for example. This can enable a dedicated type signaling that operations in a dedicated communication with particular base stations 122-1 in an ATG network. A direct radio link is enabled between the base station 122-1 as an ATG base station 122-1 on the ground and the CPE type UE mounted on the aircraft UE 110-1 or 110-2.

ATG network operation has advantages, including high throughput, low propagation delay, and low cost application. Amidst operators and the aircraft industry indicating a demand for the deployment of ATG, an increased urgency arises to standardize ATG processes, especially for the coexistence of ATG and IMT. For satellite, high altitude pseudo satellites (HAPS) and ATG, aspects can differ significantly by node definitions, spectrum considerations and co-existence considerations, for example. ATG is able to operate within existing bands and does not necessarily require new bands, particularly where operative techniques can be leveraged and characteristics for ATG network deployment scenarios are considered from trials and commercial adaptation.

In order to control the network deployment cost and considering the limited number of flights, large inter-site distance (ISD) or cell coverage range is preferred, such as up to 300 kilometers (km) (e.g., about 100 km to 200km). At the same time, when the plane UE 110-1 or 110-2 is above the sea or ocean, the distance between the plane UE 110-1 or 110-2 and the nearest base station (122-1 or 122-2) could be more than 200 km and even up to 300 km. Therefore, the ATG network should be able to provide up to 300 km cell coverage range. Further, operators are generally interested in adopting the same frequency for deploying both ATG and TN networks to save frequency resource cost, while interference between ATG and terrestrial networks becomes non-negligible. For example, about 4.8 GHz is one frequency that can be considered for both ATG and a terrestrial NR network or TN network. In addition, the on-board ATG terminal can be much more powerful than a normal terrestrial UE such as with a higher effective isotropic radiated power (EIRP) through a much larger transmission power or a much larger on-board antenna gain. As such, considering the particularity of ATG network deployment, the extreme large cell coverage range (e.g., up to 300 km) and flight speed (e.g., up to 1200 km/h), coexistence between ATG and the TN network, and ATG BS/UE core and performance requirements demand cell phase timing misalignment considerations to ensure seamlessness and quality of high speed connectivity for passengers of the airplane UEs 110-1 and 110-2. Such in-flight connectivity solutions can ensure that passengers are able to consistently use their own devices in all phases of their flight, with high data rate connection.

Each network from base station 122-1 to base station 122-2 can operate to ensure that radio frames are time and phase aligned for the plane UEs (110-1 or 110-2). However, handling of cell phase timing misalignment can be challenging where a propagation time difference between base stations 122-1 to 122-2 can be up to 600 km or about 2 milliseconds (ms) in round trip time (RTT). When the UE 110-1 or 110-2 receives indication to enable a transmit timing difference for a timing synchronization between two cells for UE measurement, the UE can assume a frame boundary alignment (including half frame, subframe and slot boundary alignment) across cells on the same frequency carrier is going to be within a tolerance not worse than min(2 SSB symbols, 1 PDSCH symbol) and the SFNs of all cells on the same frequency carrier are the same. With ATG network alignment, the UE 110-1 or 110-2 this indication (e.g., deriveSSB-IndexFromCell) can also indicate a propagation delay difference so that an additional offset is configured on top of the transmit timing difference. According to the transmit timing difference and the propagation delay difference the UE 110-1 or 110-2 can determine a total time difference. If the total time difference satisfies a predefined threshold between the two cells on the same frequency one or more UE behaviors can be configured for intra-cell frequency identification and a scheduling restriction window for synchronizing communications among the different networks.

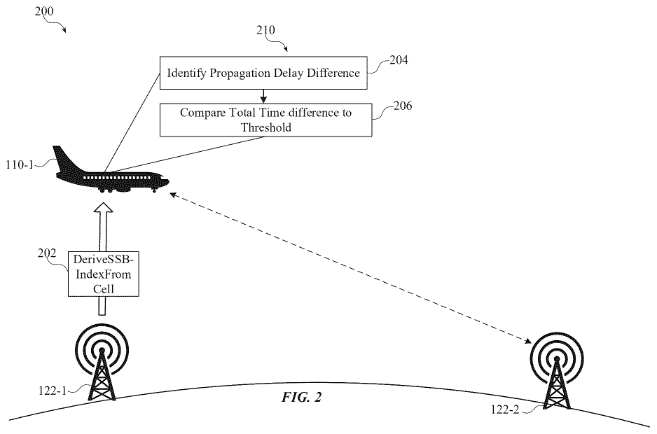

FIG. 2 illustrates another example wireless system 200 for ATG communications. The base station 122-1 provides UE 110-1 with an indication 202 of whether to enable a transmit (Tx) timing difference between the base stations 122-1 and 122-2. For example, the indication 202 can be deriveSSB-IndexFromCell. When enabled or indicated as true/active, the UE 110-1 assumes that a frame boundary alignment (including half frame, subframe and slot boundary alignment) across cells of base stations 122-1 and 122-2 on the same frequency carrier is within a tolerance not worse than a minimum of 2 SSB symbols or 1 PDSCH symbol, represented as: min(2 SSB symbols, 1 PDSCH symbol; and that the system frame numbers (SFNs) of all cells on the same frequency carrier are the same. Thus, the cell networks of base station 122-1 and 122-2 can be considered aligned or synchronous. The base station 122-1 indicates the indication 202 as deriveSSB-IndexFromCell, for example, to indicate to the UE 110-1 a timing synchronization between the two cells of base stations 122-1 and 122-2 to enable UE measurements of the network resources. The transmit timing difference that is enabled by indication 202 when true can be a predefined value or signaled to the UE by a higher layer signaling, for example.

The base station 122-1 can be an ATG base station that provides an ATG network to the plane UE 110-1, or a TN network, for example. When the base station 122-1 provides an ATG network as an ATG base station, and when the indication 202 is set to true, then the UE 110-1 further attempts to determine a propagation delay difference as an offset that is derived by the UE 110-1 or additionally indicated by the network via base station 122-2 for example. Although the signaling of the indication 202 as deriveSSB-IndexFromCell may be enabled/true, the target cell of base station 122-2 for measurement is offset by the propagation delay time difference between serving cell and target cell, especially given the potential speed and distance range that the UE 110-1 could be at when in-flight.

When the plane UE 110-1 received the indication 202 as true, the UE 110-1 performs a process flow 210 that initiates at 204 with identifying the propagation delay difference. In an aspect, the propagation delay difference between cells on a same frequency carrier can be derived from the UE 110-1 based on a location of the UE 110-1 and the location of the target networks from base station 122-1 or 122-2. The UE 110-1 can ascertain geographical location data from a global positioning system or the International Multi-Constellation Satellite System as a Global Navigation Satellite System (GNSS) to identify its UE location. In addition, if the network (e.g., of base station 122-1) can share the gNB location of the target cell of base station 122-2 to the UE 110-1, the UE 110-1 can derive the propagation delay difference based on a location of the UE 110-1 and the location of the target network.

Alternatively, or additionally, the UE 110-1 can derive the propagation delay difference between the serving cell of base station 122-1 and the target cell of base station 122-2 based on a UE system frame number (SFN) and Frame Timing Difference (SFTD) measurement. If the UE 110-1, for example, is not able to obtain the information of propagation delay difference from the network and is also not aware of the gNB location to derive the propagation delay difference, the UE 110-1 can be configured to use a downlink (DL) timing measurement on serving and neighbor (or target) cells to obtain the SFTD (i.e., received a timing difference) between those cells. Because in this case the network indicates that the deriveSSB-IndexFromCell is true to UE 110-1, it means the transmit timing difference is within a small range, i.e., the transmit side is synchronized, then the received timing difference (SFTD) can represent the propagation delay difference from those two cells. In this manner, the UE 110-1 can derive the propagation delay difference based on the SFTD measurement.

Alternatively, or additionally, the UE 110-1 can receive another indication by the network pertaining to the offset when the UE reports its location to the network.

Here, the UE 110-1 operates to report its location to the network (e.g., cell of base station 122-1 or 122-2), and the network determines the propagation delay difference.

The network or base station 122-1, for example, can receive the UE's location. Along with the base station/gNB location, the base station 122-1 can use the UE's location to determine the offset to be added to the transmit timing difference, which is predefined for use when the indication 202 is enabled.

At 206, the UE 110-1 further determines a total time difference that is based on the transmit timing difference plus the propagation delay difference: Tx timing difference +propagation delay difference, between the two cells on the same frequency. Then the UE 110-1 operates to compare the total time difference to a predefined threshold or a total time difference threshold between two cells for ATG networks. Alternatively, this threshold can be configured and signaled by the network or a higher layer signaling. Based on whether the total time difference satisfies this threshold, the UE 110-1 can further operate to perform infra-frequency cell identification with or without performing an SSB index reading. If the total time difference is below a threshold, the UE 110-1 can perform an intra-frequency cell identification and measurement without performing an SSB index reading, and SSB index can be derived from its serving cell of base station 122-1 for example, even though the UE is indicated to report SSB based radio resource management (RRM) measurement result with the associated SSB index when indicated to do so (e.g., when a report quantity reference signal (RS) indexes (reportQuantityRsIndexes) indication or a maximum number of RS indexes to report (maxNrofRSIndexesToReport) indication is configured).

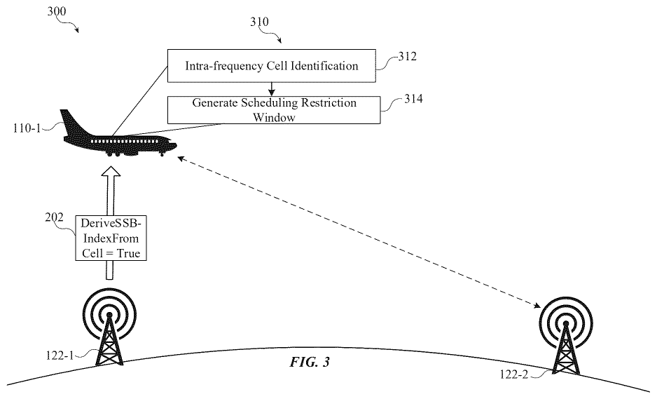

FIG. 3 illustrates another example wireless system 300 for ATG communications. The UE 110-1 obtains an indication 202 as deriveSSB-IndexFromCell for the transmit timing difference between serving and target cells, which is enabled as true. Upon identifying a total transmit time based on the transmit timing difference and a propagation delay difference and the total transmit time being below a threshold, the UE 110-1 can perform process flow 310 initiating at 312 with performing an intra-frequency cell identification.

UE 110-1 can use a serving cell SSB index to derive the target intra-frequency cell SSB index if this indication 202 is true. The UE 110-1 can identify a new detectable intra-frequency cell within a Tidentify_intra_without_index if the UE110-1 is not indicated to report SSB based RRM measurement result with the associated SSB index (where reportQuantityRsIndexes or maxNrofRSIndexes ToReport is not configured), or the UE-1 110 is indicated that the target or neighbor cell is synchronous with the serving cell (deriveSSB-IndexFromCell is enabled). Otherwise, the UE 110-1 can identify a new detectable intra frequency cell within Tidentify_intra_with_index.

In an aspect, if the total time difference is below a threshold, then the UE can perform Intra-frequency cell identification and measurement (of the target cell identified) without the SSB index reading, even though the network configures the UE to perform such SSB index reading. Because as long as the UE 110-1 can be confident that the transmit timing difference is below a threshold, then the target/neighbor cell SSB index can be derived directly from your current serving cell of base station 122-1 (as serving cell). Thus, the UE 11-1 can first check whether the total time difference is above or below a threshold. If below, UE 110-1 can skip the reading for the neighbor cell, but directly use the same timing from the serving cell of serving base station 122-1. Then, the SSB index can be derived from the UE's current serving cell; even though the UE is indicated to report SSB based RRM measurement result with the associated SSB index (where reportQuantityRsIndexes or maxNrofRSIndexes ToReport is configured). As indicated above, the threshold can be a predefined value or configured by the network and signaled to the UE 110-1 by the base station 122-2 or a higher layer signaling, for example.

At 314, the UE 110-1 can further generate a scheduling restriction window as a part of its UE behavior in response to the indication 202 being enabled. The UE 110-1 can configure a scheduling restriction window based on the offset from the propagation delay difference. In response to obtaining the transmit timing difference information the UE 110-1 can offset a scheduling restriction window will be offset by the propagation delay difference, or the window itself can be extended by certain number of X symbol as an X symbol offsetting, where X can be derived from the propagation delay difference. During the scheduling restriction window the UE 110-1 is not expected to transmit or receive data/control/reference signal transmission (e.g., transmit physical uplink shared channel (PUSCH)/physical uplink control channel (PUCCH)/sounding reference signal (SRS), or receive PDCCH/PDSCH/tracking reference signal (TRS)/channel state information reference signal (CSI-RS) for channel quality indication (CQI)) except on target SSBs of the target cell, for example.

In an aspect, the scheduling restriction window can be configured according to an X symbol offsetting from the SSB symbols to be measured and including Y data symbols before and after each of the consecutive SSB symbols to be measured within an SMTC window duration. In other words, if the indication 202, as deriveSSB_IndexFromCell, is enabled or true, the UE 110-1 is not expected to transmit PUCCH/PUSCH/SRS or receive PDCCH/PDSCH/TRS/CSI-RS for CQI on symbols with X symbol offset from SSB symbols to be measured, and on Y data symbol before each consecutive SSB symbols to be measured and Y data symbol after each consecutive SSB symbols to be measured within SMTC window duration. X symbol(s) of the X symbol offsetting is derived from the propagation delay difference, and Y is a predefined value based on the transmit timing difference with a defined margin of symbols as a tolerance value. Y can be a predefined value based on the gNB transmit timing difference with a certain margin. The X symbol(s) offsetting can indicate that if SSB symbols are from n to n+k, with X symbol offsetting the impacted symbols are from n+X to n+k+X; and the Y symbols before n+X and Y symbols after n+k+X, for the scheduling restriction window.

Alternatively, or additionally, the scheduling restriction window can be configured by the UE 110-1 without any offsetting for the scheduling restriction, but rather the scheduling restriction window can be extended. The scheduling restriction window would include X symbols to be measured and the Y data symbol before and after each consecutive SSB symbols to be measured. In other words, if the indication 202, as the deriveSSB_IndexFromCell, is enabled, the UE 110-1 is not expected to transmit PUCCH/PUSCH/SRS or receive PDCCH/PDSCH/TRS/CSI-RS for CQI on SSB symbols to be measured, and on Y data symbol before each consecutive SSB symbols to be measured and Y data symbol after each consecutive SSB symbols to be measured within an SMTC window duration. Y can be a predefined value as an integer, for example, that is based on the total time difference including the offset X and the transmit timing difference with a certain margin. The offset X can be based on the propagation delay difference between the two base stations, as the time difference for signals to reach arrival or a time of arrival from the base station to the UE 110-1, for example.

The SMTC defines a measurement timing configuration for intra-frequency measurements, such as timing occasions at which the UE 110-1 measures SSBs. If this field is absent, the UE 110-1 can assume that the SSB periodicity is a particular value (e.g., 5 ms for the intra-frequency cells). It contains following two IEs, for example: “duration” configures the duration in subframes of the measurement window in which to receive SSB blocks, and “periodicity AndOffset” configures periodicity and offset of the measurement window in which to receive SSB blocks.

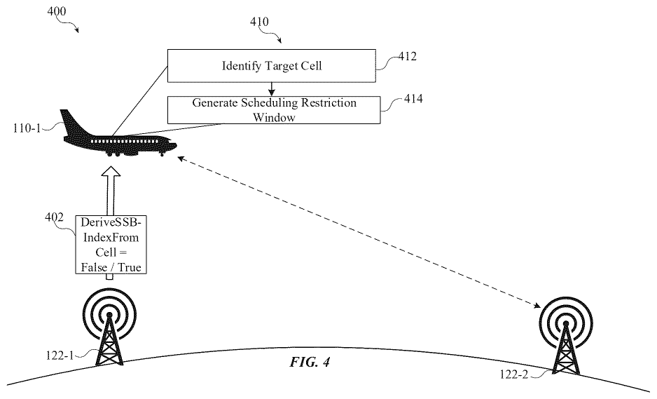

FIG. 4 illustrates another example wireless system 400 for ATG communications. The UE 110-1 obtains an indication 402, as deriveSSB-IndexFromCell, for the transmit timing difference between the serving and target cells of base stations 122-1 and 122-2, respectively, which can indicate enabled/true, or not enabled/false.

At 412 of the process flow 410 the UE identifies the target cell of the base station 122-2 as an ATG cell or not (e.g., a TN cell). The UE 110-1 can perform this identification as either a part of an initial access procedure (e.g., RACH random access procedure) based on an identifier in a system information. Alternatively, depending on operator network deployment, if the UE 110-1 is not able to access the TN network, the UE can determine whether the target cell of the base station 122-2 is an ATG network or not. If the target network or cell is identified as an ATG network at 412, then regardless of whether the indication 402 is enabled true or not enabled false the UE 110-1 will treat the indication as false.

In one example, if the UE 110-1 determines the base station 122-2 to be a TN network and the indication 402 is true, then the UE 110-1 operates as if the indication 402 is false. When the indication 402 is read or treated as false, the target cell network is treated as an asynchronous network. This means that as long as the UE identifies that the target cell of base station 122-2 is an ATG cell, then no matter this deriveSSBIndexFromCell is false or true, the UE will handle this neighbor cell as an asynchronous cell. When the neighbor cell is an asynchronous cell then two use cases for the intra-frequency cell identification and measurement perform an SSB index reading. That means the UE 110-1 may not be able to derive the neighbor cell SSB index from the current serving cell because it assumes the cells are asynchronous. The UE 110-1 can perform the intra-frequency cell identification and measurement by performing an SSB index reading as long as the UE 110-1 is indicated to report an SSB based RRM measurement result with the associated SSB index (where reportQuantityRsIndexes or maxNrofRSIndexes ToReport is configured).

At 414, the UE 110-1 generates a scheduling restriction window. The scheduling restriction window is assumed to be the entire SMTC window duration. Because the UE 110-1 in this scenario cannot necessarily determine a concrete window for example on those SSB symbols or something before or after the SSB symbols, a scheduling issue arises. Instead, the UE 110-1 assumes that the whole SMTC window will be the scheduling restriction window. The UE 110-1 is not expected to transmit PUCCH/PUSCH/SRS or receive PDCCH/PDSCH/TRS/CSI-RS for CQI on all symbols within SMTC window duration. Here, the UE 110-1 does not transmit or receive data/control/reference signal transmission except on target SSBs of the target cell.

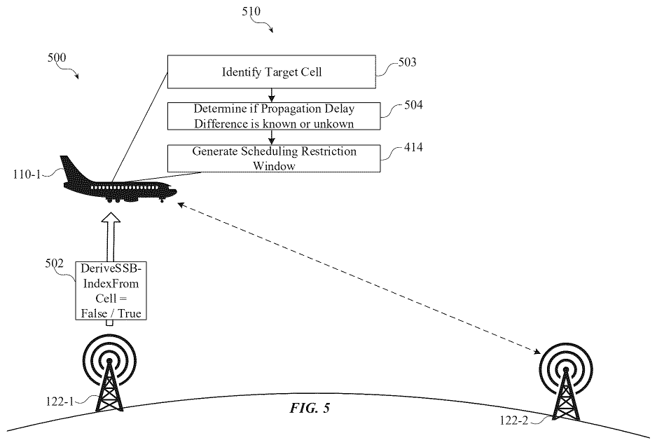

FIG. 5 illustrates another example wireless system 500 for ATG communications. The UE 110-1 obtains an indication 502, as deriveSSB-IndexFromCell, for the transmit timing difference between the serving and target cells of base stations 122-1 and 122-2, respectively, which can indicate enabled/true, or not enabled/false. Similar to the process flow 410 of FIG. 4, the UE determines whether the target cell is an ATG cell or not at 503, and similarly generates a scheduling restriction window 414 as in FIG. 4. In addition, even though the UE 110-1 may determine that the target cell is an ATG cell, the UE 110-1 at 504 further checks or determines whether the propagation time difference between the serving and the target is unknown. If unknown, then the UE behavior is the same or similar as in 412 of FIG. 4 when the target cell is identified as an ATG cell network. The target cell of base station 122-2 is then treated as an asynchronous cell to the serving cell. Unknown can be determined as the result based on the following: (1) the UE location is unknown to the network, if the network determines the propagation delay difference; or (2) the gNB location is unknown to UE 110-1, if UE 110-1 determines the propagation delay difference. Thus, in response to determining that a target cell is an ATG cell, and that the location of the UE is unknown by the ATG network when the ATG network indicates the propagation delay difference or the base station location is unknown when the UE determines the propagation delay difference, the UE 110-1 can determine the indication as not enabled.

In response to the target cell being an ATG cell, and the propagation delay difference between base stations 122-1 and 122-2 being unknown, the UE 110-1 performs intra-frequency cell identification and measurement by performing an SSB index reading as long as the UE is indicated to report SSB based RRM measurement result with the associated SSB index (e.g., where reportQuantityRsIndexes or maxNrofRSIndexesToReport is configured). The scheduling restriction window is further generated such that the UE 110-1 is not expected to transmit PUCCH/PUSCH/SRS or receive PDCCH/PDSCH/TRS/CSI-RS for CQI on all symbols within SMTC window duration, except on target SSBs of the target cell

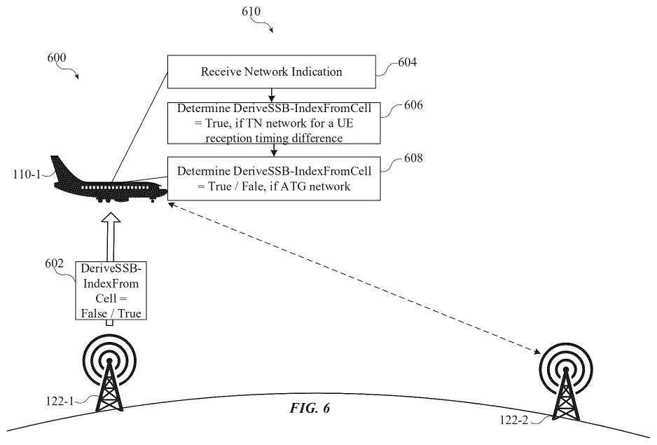

FIG. 6 illustrates another example wireless system 600 for ATG communications. The process 610 can further include the UE 110-1 receiving the indication 602 in order to enable a UE reception timing difference, which can indicate a difference in reception between the base stations 122-1 and 122-2 along with the UE's location via GNSS or other geographical location information. At 604, the UE 110-1 can further receive a network indication of whether a target network is a TN network or another ATG network. The base station 122-1 for example can provide such network indication through signaling with the base station 122-2 or a higher layer signaling and communicate this to the UE 110-1 based on its location and direction, for example.

If the network indication at 604 indicates a TN network, at 606 the UE 110-1 can determine the indication 602 as enabled for a UE reception timing difference. At 608, in response to the target network of base station 122-2 is another ATG network, the UE 110-1 can determine the indication 602 as enabled for the transmit timing difference, or determine the target network as an asynchronized cell as not enabled. Based on this determination, the process flows or one or more acts of process flow 210 thru 510 can be processed.

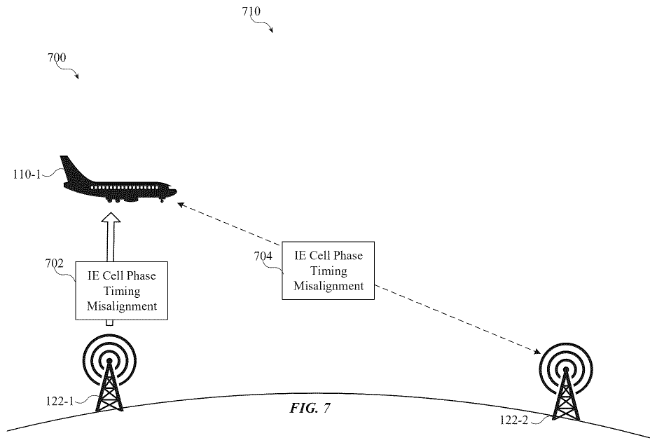

FIG. 7 illustrates another example wireless system 600 for ATG communications. For ATG networks, an information element (IE) of a cell phase timing misalignment signaling 702 and 704 can be configured either by one or both the serving cell and target cell of base stations 122-1 and 122-2. The IEs 702 or 704 can indicate values that enable a total time difference to the UE to be determined, in particular if the UE location is known to the network of base station 122-1. Thus, if the network knows the UE location relative to the network and also knows the gNB location of the base station 122-2, then the network can know the timing or arrival signaling vector to provide the cell phase time difference between different gNBs 122-1 and 122-2 to indicate that time difference to the UE 110-1. Each gNB could also provide an IE with different values for the UE to determine the cell phase timing misalignment. After the UE gets this time total time difference, the UE behavior is then similar or the same as the process flows or one or more acts of process flow 210 thru 610 of FIG. 2 thru 6.

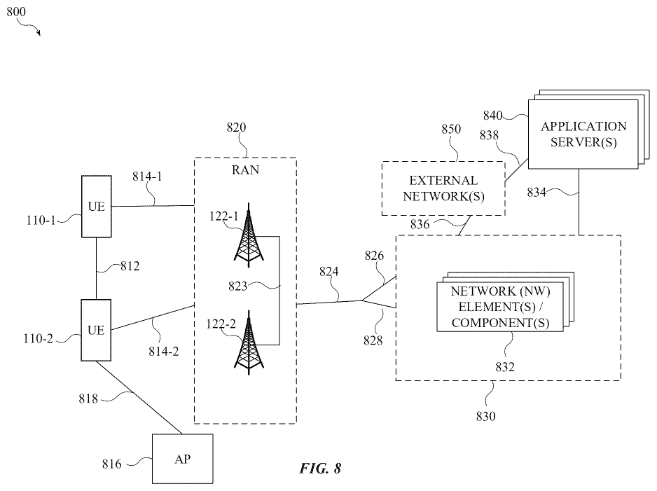

FIG. 8 is an example network 800 according to one or more implementations described herein. Example network 800 can include UEs 110-1, 110-2, etc. (referred to collectively as “UEs 110” and individually as “UE 110”), a radio access network (RAN) 820, a core network (CN) 830, application servers 840, or external networks 850.

The systems and devices of example network 800 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 800 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 can include smartphones (e.g., handheld touchscreen mobile computing devices connectable to one or more wireless communication networks). Additionally, or alternatively, UEs 110 can include other types of mobile or non-mobile computing devices capable of wireless communications, such as personal data assistants (PDAs), pagers, laptop computers, desktop computers, wireless handsets, etc. In some implementations, UEs 110 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Additionally, UEs 110 can be NTN UEs that are capable of being communicatively coupled to satellites in an NTN network.

UEs 110 can communicate and establish a connection with (be communicatively coupled to) RAN 820, which can involve one or more wireless channels 814-1 and 814-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 822-1 and 822-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 830. Additionally, at least one of the MN or the SN can be operated with shared spectrum channel access, and functions specified for UE 110 can be used for an integrated access and backhaul mobile termination (IAB-MT). Similar for UE 110, the IAB-MT can access the network using either one network node or using two different nodes with enhanced dual connectivity (EN-DC) architectures, new radio dual connectivity (NR-DC) architectures, or other direct connectivity such as a sidelink (SL) communication channel as an SL interface 812.

In some implementations, a base station (as described herein) can be an example of network node 822. As shown, UE 110 can additionally, or alternatively, connect to access point (AP) 816 via connection interface 818, which can include an air interface enabling UE 110 to communicatively couple with AP 816. AP 816 can comprise a wireless local area network (WLAN), WLAN node, WLAN termination point, etc. The connection 818 can comprise a local wireless connection, such as a connection consistent with any IEEE 702.11 protocol, and AP 816 can comprise a wireless fidelity (Wi-Fi®) router or other AP. AP 816 could be also connected to another network (e.g., the Internet) without connecting to RAN 820 or CN 830.

RAN 820 can also include one or more RAN nodes 822-1 and 822-2 (referred to collectively as RAN nodes 822, and individually as RAN node 822) that enable channels 814-1 and 814-2 to be established between UEs 110 and RAN 820. RAN nodes 822 can include network access points configured to provide radio baseband functions for data or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 822 can include a roadside unit (RSU), a transmission reception point (TRxP or TRP), and one or more other types of ground stations (e.g., terrestrial access points). In some scenarios, RAN node 822 can be a dedicated physical device, such as a macrocell base station, or a low power (LP) base station for providing femtocells, picocells or other like having smaller coverage areas, smaller user capacity, or higher bandwidth compared to macrocells.

Some or all of RAN nodes 822 can be implemented as one or more software entities running on server computers as part of a virtual network, which can be referred to as a centralized RAN (CRAN) or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 822; a media access control (MAC)/physical (PHY) layer split wherein RRC, PDCP, radio link control (RLC), and MAC layers can be operated by the CRAN/vBBUP and the PHY layer can be operated by individual RAN nodes 822; or a “lower PHY” split wherein RRC, PDCP, RLC, MAC layers and upper portions of the PHY layer can be operated by the CRAN/vBBUP and lower portions of the PHY layer can be operated by individual RAN nodes 822. This virtualized framework can allow freed-up processor cores of RAN nodes 822 to perform or execute other virtualized applications.

In some implementations, an individual RAN node 822 can represent individual gNB-distributed units (DUs) connected to a gNB-control unit (CU) via individual F1 interfaces. In such implementations, the gNB-DUs can include one or more remote radio heads or radio frequency (RF) front end modules (RFEMs), and the gNB-CU can be operated by a server (not shown) located in RAN 820 or by a server pool (e.g., a group of servers configured to share resources) in a similar manner as the CRAN/vBBUP. Additionally, or alternatively, one or more of RAN nodes 822 can be next generation eNBs (i.e., gNBs) that can provide evolved universal terrestrial radio access (E-UTRA) user plane and control plane protocol terminations toward UEs 110, and that can be connected to a 5G core network (5GC) 830 via an NG interface.

Any of the RAN nodes 822 can terminate an air interface protocol and can be the first point of contact for UEs 110. In some implementations, any of the RAN nodes 822 can fulfill various logical functions for the RAN 820 including, but not limited to, radio network controller (RNC) functions such as radio bearer management, uplink and downlink dynamic radio resource management and data packet scheduling, and mobility management. UEs 110 can be configured to communicate using orthogonal frequency-division multiplexing (OFDM) communication signals with each other or with any of the RAN nodes 822 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations can not be limited in this regard. The OFDM signals can comprise a plurality of orthogonal subcarriers.

Further, RAN nodes 822 can be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can include channels that operate in a frequency range (e.g., approximately 400 MHz to approximately 3.8 GHz, or other range). In some regions, the unlicensed spectrum can include about the 5 GHz band, for example, or other frequency bands. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 822 can operate using licensed assisted access (LAA), eLAA, and/or feLAA mechanisms. In these implementations, UEs 110 and the RAN nodes 822 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol or a clear channel assessment (CCA).

A physical downlink shared channel (PDSCH) can carry user data and higher layer signaling to UEs 110. The physical downlink control channel (PDCCH) can carry information about the transport format and resource allocations related to the PDSCH channel, among other things. The PDCCH can also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) can be performed at any of the RAN nodes 822 based on channel quality information fed back from any of UEs 110. The downlink resource assignment information can be sent on the PDCCH used for (e.g., assigned to) each of UEs 110.

The PDCCH uses control channel elements (CCEs) to convey the control information, wherein a number of CCEs (e.g., 6 or the like) can consists of a resource element groups (REGs), where a REG is defined as a physical resource block (PRB) in an OFDM symbol. Before being mapped to resource elements, the PDCCH complex-valued symbols can first be organized into quadruplets, which can then be permuted using a sub-block interleaver for rate matching, for example. Each PDCCH can be transmitted using one or more of these CCEs, where each CCE can correspond to nine sets of four physical resource elements known as REGs. Four quadrature phase shift keying (QPSK) symbols can be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, 8, or 16).

The RAN nodes 822 or RAN 820 can be configured to communicate with one another via interface 823. In implementations where the system is an LTE system, interface 824 can be an X2 interface. The X2 interface can be defined between two or more RAN nodes 822 (e.g., two or more eNBs/gNBs or a combination thereof) that connect to evolved packet core (EPC) or CN 830, or between two eNBs connecting to an EPC. In some implementations, the X2 interface can include an X2 user plane interface (X2-U) 826 and an X2 control plane interface (X2-C) 828. The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

Alternatively, or additionally, RAN 820 can be also connected (e.g., communicatively coupled) to CN 830 via a Next Generation (NG) interface as interface 824. The NG interface 824 can be split into two parts, a Next Generation (NG) user plane (NG-U) interface 826, which carries traffic data between the RAN nodes 822 and a User Plane Function (UPF), and the S1 control plane (NG-C) interface 828, which is a signaling interface between the RAN nodes 822 and Access and Mobility Management Functions (AMFs).

CN 830 can comprise a plurality of network elements 832, which are configured to offer various data and telecommunications services to customers/subscribers (e.g., users of UEs 110) who are connected to the CN 830 via the RAN 820. In some implementations, CN 830 can include an evolved packet core (EPC), a 5G CN, and/or one or more additional or alternative types of CNs. The components of the CN 830 can be implemented in one physical node or separate physical nodes including components to read and execute instructions from a machine-readable or computer-readable medium (e.g., a non-transitory machine-readable storage medium).

As shown, CN 830, application servers 840, and external networks 850 can be connected to one another via interfaces 834, 836, and 838, which can include IP network interfaces. Application servers 840 can include one or more server devices or network elements (e.g., virtual network functions (VNFs) offering applications that use IP bearer resources with CN 830 (e.g., universal mobile telecommunications system packet services (UMTS PS) domain, LTE PS data services, etc.). Application servers 840 can also, or alternatively, be configured to support one or more communication services (e.g., voice over IP (VOIP sessions, push-to-talk (PTT) sessions, group communication sessions, social networking services, etc.) for UEs 110 via the CN 830. Similarly, external networks 850 can include one or more of a variety of networks, including the Internet, thereby providing the mobile communication network and UEs 110 of the network access to a variety of additional services, information, interconnectivity, and other network features.

Various aspects herein can include the UE 110-1 communicating in an ATG network as an airplane in-flight. The UE 110-1 can receive an indication to enable or not enable a transmit timing difference between base stations on a same frequency carrier. A propagation delay difference between cells of the plurality of base stations based on a location of the UE and a base station location from an ATG network, based on a derivation according to a UE SFTD, or based on an indication by the ATG network.

Then a total time difference can be determined based on the transmit timing difference and the propagation delay difference, and whether the total time difference satisfies a predefined threshold. An intra-frequency cell identification and measurement can be performed then based on the total time difference and satisfaction of threshold or not in accord with various aspects described herein.

The UE 110-1 or 110-2 is configured to process, perform, generate, communicate or cause execution of any one or more combined aspects described herein or in association with FIG. 1 thru FIG. 7.

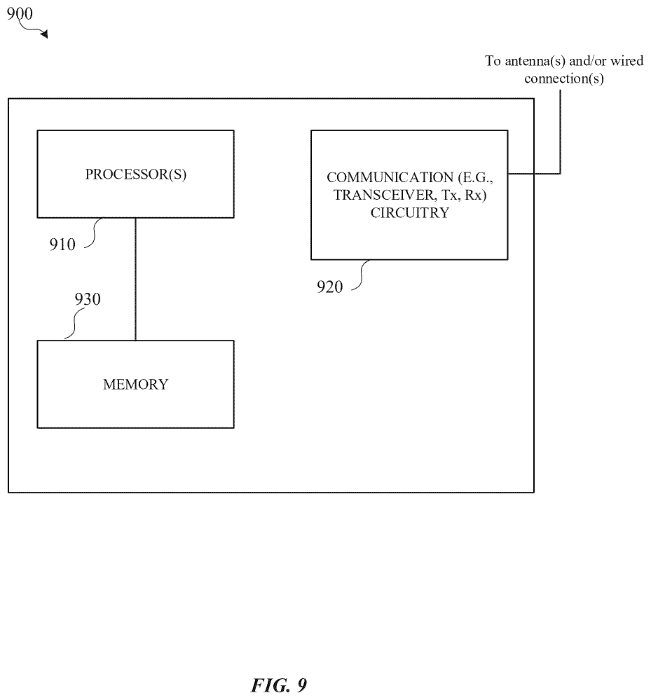

FIG. 9 illustrates is a block diagram of a UE device or another network device/component such as UE 110-1 or UE 110-2 for cell phase timing alignment for ATG networking. The device 900 includes one or more processors 910 (e.g., one or more baseband processors) comprising processing circuitry, which can correspond to controller 104, for example. The device 900 further can comprise associated interface(s), transceiver circuitry 920 (e.g., comprising RF circuitry, which can comprise transmitter circuitry (e.g., associated with one or more transmit chains, as transceiver/transmitter 106) and/or receiver circuitry (e.g., associated with one or more receive chains) that can employ common circuit elements, distinct circuit elements, or a combination thereof), and a memory 930 (which can comprise any of a variety of storage mediums and can store instructions and/or data associated with one or more of processor(s) 910 or transceiver circuitry 920). The UE 900 can also represent the UE 110-1 or 110-2, for example.

Memory 930 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection can also be termed a computer-readable medium.

The UE 900 can operate or be configured as 110-1 or 110-2 to process, perform, generate, communicate or cause execution of any one or more combined aspects described herein or in association with FIG. 1 thru FIG. 8.

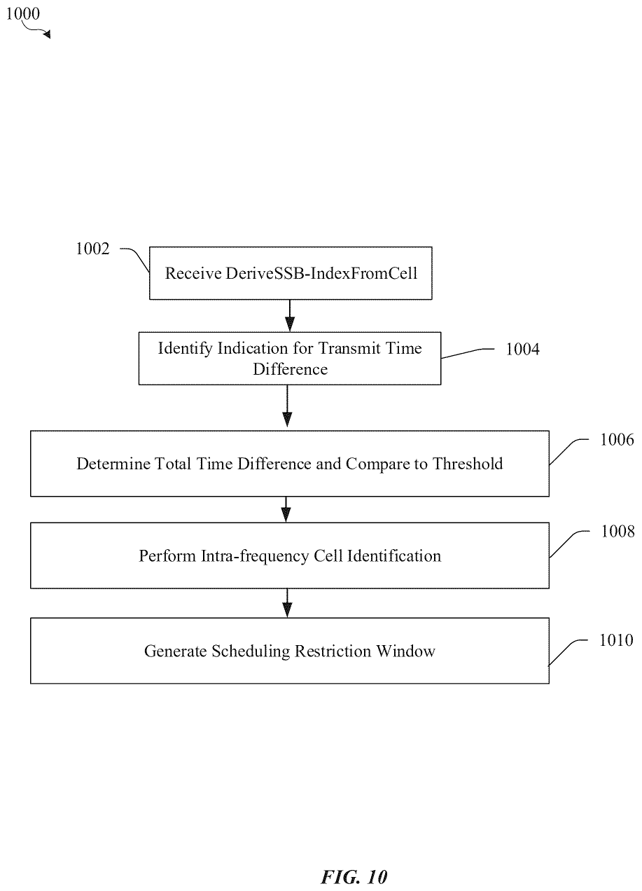

FIG. 10 illustrates an example process flow 1000 for cell phase timing misalignment handling across ATG networks with an in-flight airplane UE or CPE UE in flight. The process flow 1000 initiates at 1002 with receiving an indication to enable or not enable a transmit timing difference between base stations on a same frequency carrier. At 1004, the process flow 1000 includes identifying a propagation delay difference between cells of the plurality of base stations based on a location of the UE and a base station location from an ATG network, based on a derivation according to a SFTD, or based on an indication by the ATG network. At 1006, the process flow includes determining a total time difference based on the transmit timing difference and the propagation delay difference, and whether the total time difference satisfies a predefined threshold. At 1008, the process flow includes performing an intra-frequency cell identification based on the total time difference.

In an aspect, in response to the total time difference being below the predefined threshold, derive a SSB index of a neighbor cell from a serving cell without performing an SSB index reading with a radio resource management (RRM) measurement. A system information block (SIB) or RRC configuration of an intra-frequency information element comprises a deriveSSB-IndexFromCell field for the indication to enable the timing difference.

At 1010 the UE 110-1, for example, can determine a scheduling restriction window based on symbols with an X symbol offsetting from consecutive SSB symbols to be measured, Y data symbols before the consecutive SSB symbols to be measured after X symbols offsetting and the Y data symbols after the consecutive SSB symbols to be measured after X symbols offsetting. The X symbol(s) of the X symbol offsetting is derived from the propagation delay difference, and Y is a predefined value based on the transmit timing difference with a defined margin.

Alternatively, or additionally, the process flow 1000 can include determining a scheduling restriction window based on a number of SSB symbols to be measured, Y data symbols before the SSB symbols to be measured and the Y data symbols after the SSB symbols to be measured. Y can be a predefined value based on the total time difference including an X symbol offset and the transmit timing difference with a defined margin.

In an aspect, the UE 110-1 in response to determining that a target cell is an ATG cell, determine the indication as not enabled, regardless of whether the indication indicates being enabled or true. The UE 110-1 then can perform an intra-frequency cell identification by performing an SSB index reading to report an SSB RRM measurement result with an associated SSB index. The UE 110-1 can identify the target cell as an asynchronous cell with a scheduling restriction window that comprises symbols within a SMTC window duration.

In another aspect, in response to determining that a target cell is an ATG cell, and that the location of the UE is unknown by the ATG network when the ATG network indicates the propagation delay difference or the base station location is unknown when the UE determines the propagation delay difference, determine the indication as not enabled. The UE 110-1 can further perform an intra-frequency cell identification and measurement thereof by performing an SSB index reading to report an SSB RRM measurement result with an associated SSB index. The scheduling restriction window can comprise symbols within an SMTC window duration, in which the UE does not transmit or receive data/control/reference signal transmission except on target SSBs of the target cell.

Additionally, or alternatively, the UE 110-1 can receive one or more different information elements from the ATG network, and determine a cell phase timing misalignment between base stations based on one or more values of the one or more different information elements, when the location of the UE is known to the ATG network.

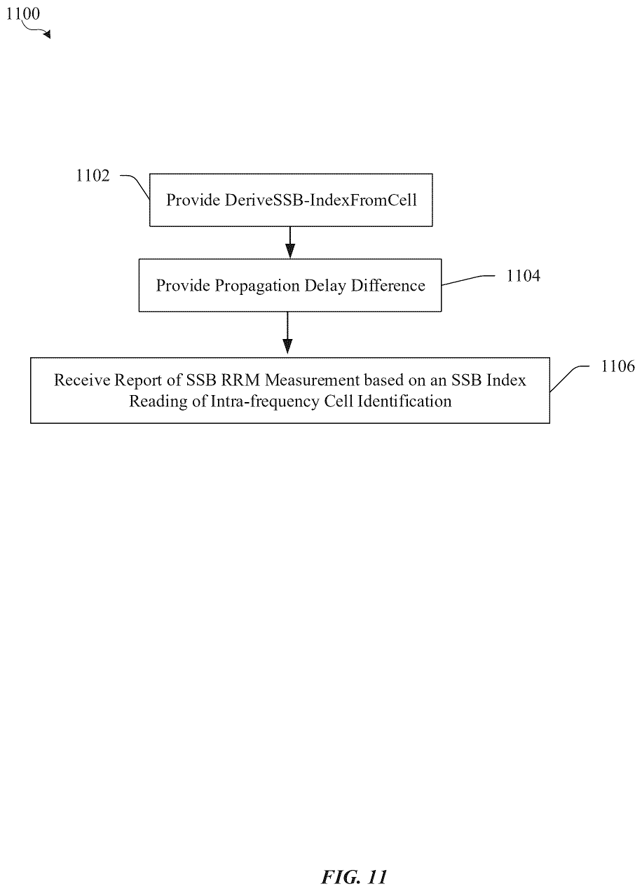

FIG. 11 illustrates another example process flow 1100 for cell phase timing misalignment handling across ATG networks in a base station in communication with an in-flight airplane UE or CPE UE in flight. The process flow 1100 initiates at 1102 with providing an indication in a SIB of an intra-frequency information element or RRC configuration by a deriveSSB-IndexFromCell field to indicate whether the UE is to utilize a serving cell timing to derive an index of synchronization signal (SS) block (SSB) of a target network based on whether the indication is enabled or not enabled. At 1104, the process flow 1100 includes providing an offset as a propagation delay difference between a current air to ground (ATG) network and the target network of a target base station based on a location of the UE and a location of the target base station in order to enable a scheduling restriction window to be derived. At 1106, the process flow can further include receiving a report of an SSB radio resource management (RRM) measurement based on an SSB index reading of an intra-frequency cell identification and measurement by the UE in response to at least one of: the target network comprise an ATG target cell or the location of the UE or the propagation delay difference is unknown.

In an aspect, the base station can also provide the offset to enable the scheduling restriction window to be derived based on SSB symbols to be measured, data symbols before and after, and the offset. A scheduling restriction window can be configured to include all symbols within a SMTC window duration.

In an aspect, the base station can further operate to provide a network indication indicating whether the target network of the target base station is a TN or another ATG network. In response to the target network being the TN network, the base station can provide the indication as enabled for a UE reception timing difference. In response to the target network being another ATG network, providing the indication in the SIB or RRC configuration as enabled for a transmit timing difference without the offset to be used for a report of an SSB RRM measurement, or for the target network to be an asynchronized cell.

While the methods described within this disclosure are illustrated in and described herein as a series of acts or events, it will be appreciated that the illustrated ordering of such acts or events are not to be interpreted in a limiting sense. For example, some acts can occur in different orders and/or concurrently with other acts or events apart from those illustrated and/or described herein. In addition, not all illustrated acts can be required to implement one or more aspects or embodiments of the description herein. Further, one or more of the acts depicted herein can be carried out in one or more separate acts and/or phases. Reference can be made to the figures described above for ease of description. However, the methods are not limited to any particular embodiment, aspect or example provided within this disclosure and can be applied to any of the systems/devices/components disclosed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure is described with reference to attached drawing figures, wherein like reference numerals are used to refer to like elements throughout, and wherein the illustrated structures and devices are not necessarily drawn to scale.

As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

A first example can be User Equipment (UE) comprising: a memory; processing circuitry, coupled to the memory, configured to, when executing instructions stored in the memory, cause the UE to: receive an indication to enable a transmit timing difference between a plurality of base stations on a same frequency carrier; identify a propagation delay difference between cells of the plurality of base stations based on a location of the UE and a base station location from an air to ground (ATG) network, based on a derivation according to a system frame number (SFN) and a timing difference (SFTD), or based on an indication by the ATG network; determine a total time difference based on the transmit timing difference, the propagation delay difference, and the indication enabling the transmit timing difference, and whether the total time difference satisfies a predefined threshold; and perform an intra-frequency cell identification and measurement based on the total time difference.

A second example can include the first example, wherein the processing circuitry is further configured to: in response to the total time difference being below the predefined threshold, derive a synchronization signal (SS) block (SSB) index of a neighbor cell from a serving cell without performing an SSB index reading with an radio resource management (RRM) measurement, wherein a system information block (SIB) or RRC configuration of an intra-frequency information element comprises a deriveSSB-IndexFromCell field for the indication to enable the transmit timing difference.

A third example can include the first or second example, wherein the processing circuitry is further configured to: determine a scheduling restriction window based on symbols with an X symbol offsetting from consecutive SSB symbols to be measured, Y data symbols before the consecutive SSB symbols to be measured after X symbols offsetting and the Y data symbols after the consecutive SSB symbols to be measured after X symbols offsetting, wherein X symbol(s) of the X symbol offsetting is derived from the propagation delay difference, and Y is a predefined value based on the transmit timing difference with a defined margin.

A fourth example can include any one or more of the first through third examples, wherein the processing circuitry is further configured to: determine a scheduling restriction window based on a number of SSB symbols to be measured, Y data symbols before the SSB symbols to be measured and the Y data symbols after the SSB symbols to be measured, wherein Y is a predefined value based on the total time difference including an X symbol offset and the transmit timing difference with a defined margin.

A fifth example can include any one or more of the first through fourth examples, wherein the processing circuitry is further configured to: in response to determining that a target cell is an ATG cell, determine the indication as not enabled, despite whether the indication indicates being enabled or true.

A sixth example can include any one or more of the first through fifth examples, wherein the processing circuitry is further configured to: perform the intra-frequency cell identification and measurement by performing an SSB index reading to report an SSB RRM measurement result with an associated SSB index.

A seventh example can include any one or more of the first through sixth examples, wherein the processing circuitry is further configured to: identify the target cell as an asynchronous cell with a scheduling restriction window that comprises symbols within a synchronization signal (SS)/physical broadcast channel (PBCH) measurement timing configuration (SMTC) window duration.

An eighth example can include any one or more of the first through seventh examples, wherein the processing circuitry is further configured to: in response to determining that a target cell is an ATG cell, and that the location of the UE is unknown by the ATG network when the ATG network indicates the propagation delay difference or the base station location is unknown when the UE determines the propagation delay difference, determine the indication as not enabled; and perform the intra-frequency cell identification and measurement by performing an SSB index reading to report an SSB RRM measurement result with an associated SSB index, wherein a scheduling restriction window comprises symbols within an SMTC window duration and where the UE does not transmit or receive data/control/reference signal transmission except on target SSBs of the target cell.

A ninth example can include any one or more of the first through eighth examples, wherein the processing circuitry is further configured to: receive a network indication of whether a target network is a terrestrial network (TN) network or another ATG network; in response to the target network being the TN network, determine the indication as enabled for a UE reception timing difference; and in response to the target network being another ATG network, determine the indication as enabled for the transmit timing difference, or determine the target network as an asynchronized cell.

A tenth example can include any one or more of the first through ninth examples, wherein the processing circuitry is further configured to: receive one or more different information elements from the ATG network; and determine a cell phase timing misalignment between the plurality of base stations based on one or more values of the one or more different information elements, when the location of the UE is known to the ATG network.

An eleventh example can be a method comprising: processing, via processing circuitry, an indication for enabling a transmit timing difference; identifying a propagation delay difference between a base station and a target base station based on a location of a user equipment (UE) and a base station location in an air to ground (ATG) network of the base station, based on a derivation according to a system frame number (SFN) and a timing difference (SFTD), or based on an indication by the ATG network; and determining a total time difference based on the indication being enabled, the transmit timing difference and the propagation delay difference for determining a UE behavior based on whether the total time difference satisfies a predefined threshold.

A twelfth example can include the eleventh example further comprising: in response to the total time difference being below the predefined threshold, determining a synchronization signal (SS) block (SSB) index of a neighbor cell from a serving cell without performing an SSB index reading with a radio resource management (RRM) measurement.

A thirteenth example can include any one or more of the eleventh through twelfth examples, further comprising: determining a scheduling restriction window based on symbols with an X symbol offsetting from consecutive SSB symbols to be measured, Y data symbols before the consecutive SSB symbols to be measured and the Y data symbols after the consecutive SSB symbols to be measured, wherein X symbol(s) of the X symbol offsetting is derived from the propagation delay difference, and Y is a predefined value based on the transmit timing difference with a defined margin; or determining a scheduling restriction window based on a number of SSB symbols to be measured, the Y data symbols before the SSB symbols to be measured and the Y data symbols after the SSB symbols to be measured, wherein Y is a predefined value based on the total time difference including an X symbol offset and the transmit timing difference with a defined margin.

A fourteenth example can include any one or more of the eleventh through fifteenth examples, further comprising: in response to determining that a target cell is an ATG cell, determining the indication as not enabled, despite whether the indication indicates being enabled or true; performing an intra-frequency cell identification and measurement by performing an SSB index reading to report an SSB RRM measurement result with an associated SSB index; and identifying the target cell as an asynchronous cell with a scheduling restriction window that comprises symbols within a synchronization signal (SS)/physical broadcast channel (PBCH) measurement timing configuration (SMTC) window duration.

A fifteenth example can include any one or more of the eleventh through fourteenth examples further comprising: in response to determining that a target cell of the target base station is an ATG cell, and that the location of the UE is unknown by the ATG network when the ATG network indicates the propagation delay difference or the base station location is unknown when the UE determines the propagation delay difference, determining the indication as not enabled; and performing an intra-frequency cell identification and measurement by performing an SSB index reading to report an SSB RRM measurement result with an associated SSB index, wherein a scheduling restriction window comprises symbols within an SMTC window duration and where the UE does not transmit or receive data/control/reference signal transmission except on target SSBs of the target cell.

A sixteenth example can include any one or more of the eleventh through fifteenth examples, further comprising: receive a network indication of whether a target network is a terrestrial network (TN) network or another ATG network; in response to the target network being the TN network, determine the indication as enabled for a UE reception timing difference; and in response to the target network being another ATG network, determine the indication as enabled for the transmit timing difference, or determine the target network as an asynchronized cell.

A seventeenth example can include any one or more of the eleventh through sixteenth examples further comprising: determine a cell phase timing misalignment between the base station and the target base station based on one or more values of one or more different information elements, when the location of the UE and a location of a target cell of the target base station is known to the ATG network.

An eighteenth example can be a base station comprising: a memory; processing circuitry, coupled to the memory, configured to, when executing instructions stored in the memory, cause the base station to: provide an indication in a system information block (SIB) of an intra-frequency information element or RRC configuration by a deriveSSB-IndexFromCell field to indicate whether a user equipment (UE) is to utilize a serving cell timing to derive an index of synchronization signal (SS) block (SSB) of a target network based on whether the indication is enabled or not enabled; and provide an offset as a propagation delay difference between a current air to ground (ATG) network and the target network of a target base station based on a location of the UE and a location of the target base station in order to enable a scheduling restriction window to be derived.

A nineteenth example can include the eighteenth example, wherein the processing circuitry is further configured to: provide the offset to enable the scheduling restriction window to be derived based on SSB symbols to be measured, data symbols before and after and the offset.

A twentieth example includes any one or more of the eighteenth through nineteenth examples, wherein the processing circuitry is further configured to: receive a report of an SSB radio resource management (RRM) measurement based on an SSB index reading of an intra-frequency cell identification and measurement by the UE in response to at least one of: the target network comprise an ATG target cell or the location of the UE or the propagation delay difference is unknown.

A twenty-first example includes any one or more of the eighteenth through twentieth examples, wherein the scheduling restriction window comprises all symbols within a synchronization signal (SS)/physical broadcast channel (PBCH) measurement timing configuration (SMTC) window duration.

A twenty-second example includes any one or more of the eighteenth through twenty-first examples wherein the processing circuitry is further configured to: provide a network indication indicating whether the target network of the target base station is a terrestrial network (TN) network or another ATG network; in response to the target network being the TN network, provide the indication as enabled for a UE reception timing difference; and in response to the target network being another ATG network, providing the indication in the SIB or RRC configuration as enabled for a transmit timing difference without the offset to be used for a report of an SSB RRM measurement, or for the target network to be an asynchronized cell.

A twenty-third example includes any one or more of the eighteenth through twenty-second examples, wherein the processing circuitry is further configured to: provide one or more different information elements from the current ATG network to indicate a cell phase timing misalignment between the current ATG network and the target network based on one or more values of the one or more different information elements, when the location of the UE is known to the ATG network.

A twenty-fourth example includes any one or more of the eighteenth through twenty-third examples, wherein the UE comprises an airplane in flight.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1. A User Equipment (UE) comprising:
a memory;
processing circuitry, coupled to the memory, configured to, when executing instructions stored in the memory, cause the UE to:
determine a transmit timing difference between a neighbor cell and a serving cell, wherein the neighbor cell and the serving cell operate on a same frequency carrier in an air to ground (ATG) network;
determine a propagation delay difference between the neighbor cell and the serving cell; and
determine a total time difference based on the transmit timing difference and the propagation delay difference,
wherein the transmit timing difference is determined based on an indication of whether a synchronization signal block (SSB) index of the neighbor cell is derived from the serving cell.

2. The UE of claim 1, wherein the processing circuitry is further configured to:
in response to the indication being that the SSB index of the neighbor cell is derived from the serving cell and the total time difference being below a predefined threshold, perform an intra-frequency cell identification and measurement by deriving the SSB index from the serving cell.

3. The UE of claim 1, wherein the processing circuitry is further configured to:
in response to the indication being that the SSB index of the neighbor cell is derived from the serving cell, determine a scheduling restriction window based on symbols with an X symbol offsetting from consecutive SSB symbols to be measured, Y data symbols before the consecutive SSB symbols to be measured after X symbols offsetting and the Y data symbols after the consecutive SSB symbols to be measured after X symbols offsetting,
wherein X symbol(s) of the X symbol offsetting is derived from the propagation delay difference, and Y is a predefined value based on the transmit timing difference with a defined margin.

4. The UE of claim 1, wherein the processing circuitry is further configured to:
in response to the indication being that the SSB index of the neighbor cell is derived from the serving cell, determine a scheduling restriction window based on a number of SSB symbols to be measured, Y data symbols before the SSB symbols to be measured and the Y data symbols after the SSB symbols to be measured, wherein Y is a predefined value based on the total time difference including an X symbol offset and the transmit timing difference with a defined margin.

5. The UE of claim 1, wherein the indication being that the SSB index of the neighbor cell is not derived from the serving cell, when the neighbor cell is an ATG cell.

6. The UE of claim 5, wherein the processing circuitry is further configured to:
perform an intra-frequency cell identification and measurement by performing an SSB index reading to report an SSB RRM measurement result of the neighbor cell.

7. The UE of claim 5, wherein the processing circuitry is further configured to:
identify the neighbor cell as an asynchronous cell with a scheduling restriction window that comprises symbols within a synchronization signal (SS)/physical broadcast channel (PBCH) measurement timing configuration (SMTC) window duration.

8. The UE of claim 1, wherein the processing circuitry is further configured to:
in response to determining that a location of the UE or the neighbor cell is unknown, determine the indication being that the SSB index of the neighbor cell is not derived from the serving cell; and
perform an intra-frequency cell identification and measurement by performing an SSB index reading to report an SSB RRM measurement result with an associated SSB index, wherein a scheduling restriction window comprises symbols within an SMTC window duration.

9. The UE of claim 1, wherein the propagation delay difference is determined based on locations of the serving cell and the neighbor cell, a derivation from system frame number and timing difference (SFTD), or an indication by the ATG network.

10. The UE of claim 1, wherein the propagation delay difference is indicated in an information element different from the indication of whether the SSB index of the neighbor cell is derived from the serving cell.

11. A method comprising:
processing, via processing circuitry, an indication for enabling a transmit timing difference derivation;
identifying a propagation delay difference between a base station and a target base station based on a location of a user equipment (UE) and a location of a base station in an air to ground (ATG) network, based on a derivation according to a system frame number (SFN) and a timing difference (SFTD), or based on an indication by the ATG network; and
determining a total time difference based on the indication being enabled and the propagation delay difference for determining a UE behavior based on whether the total time difference satisfies a predefined threshold.

12. The method of claim 11, further comprising:
in response to the total time difference being below the predefined threshold, determining a synchronization signal (SS) block (SSB) index of a neighbor cell from a serving cell without performing an SSB index reading with a radio resource management (RRM) measurement.

13. The method of claim 11, further comprising:
determining a scheduling restriction window based on symbols with an X symbol offsetting from consecutive SSB symbols to be measured, Y data symbols before the consecutive SSB symbols to be measured and the Y data symbols after the consecutive SSB symbols to be measured, wherein X symbol(s) of the X symbol offsetting is derived from the propagation delay difference, and Y is a predefined value based on a transmit timing difference with a defined margin; or
determining a scheduling restriction window based on a number of SSB symbols to be measured, the Y data symbols before the SSB symbols to be measured and the Y data symbols after the SSB symbols to be measured, wherein Y is a predefined value based on the total time difference including an X symbol offset and the transmit timing difference with another defined margin.

14. The method of claim 11, further comprising:
in response to determining that a target cell is an ATG cell, determining the indication as not enabled;
performing an intra-frequency cell identification and measurement by performing an SSB index reading to report an SSB RRM measurement result with an associated SSB index; and
identifying the target cell as an asynchronous cell with a scheduling restriction window that comprises symbols within a synchronization signal (SS)/physical broadcast channel (PBCH) measurement timing configuration (SMTC) window duration.

15. The method of claim 11, further comprising:
in response to determining that a target cell of the target base station is an ATG cell, and that the location of the UE is unknown by the ATG network when the ATG network indicates the propagation delay difference or the location of the base station is unknown when the UE determines the propagation delay difference, determining the indication as not enabled; and
performing an intra-frequency cell identification and measurement by performing an SSB index reading to report an SSB RRM measurement result with an associated SSB index, wherein a scheduling restriction window comprises symbols within an SMTC window duration and where the UE does not transmit or receive data/control/reference signal transmission except on target SSBs of the target cell.

16. The method of claim 11, further comprising:
receive a network indication of whether a target network is a terrestrial network (TN) network or another ATG network;
in response to the target network being the TN network, determine the indication as enabled for a UE reception timing difference; and
in response to the target network being another ATG network, determine the indication as enabled for a transmit timing difference, or determine the target network as an asynchronized cell.

17. The method of claim 11, further comprising:
determine a cell phase timing misalignment between the base station and the target base station based on one or more values of one or more different information elements, when the location of the UE and a location of a target cell of the target base station is known to the ATG network.

18. A base station comprising:
a memory;
processing circuitry, coupled to the memory, configured to, when executing instructions stored in the memory, cause the base station to:
provide an indication in a system information block (SIB) of an intra-frequency information element or RRC configuration by a deriveSSB-IndexFromCell field to indicate whether a user equipment (UE) is to utilize a serving cell timing to derive an index of synchronization signal (SS) block (SSB) of a target network based on whether the indication is enabled or not enabled; and
provide an offset as a propagation delay difference between a current air to ground (ATG) network and the target network of a target base station based on a location of the UE and a location of the target base station in order to enable a scheduling restriction window to be derived.

19. The base station of claim 18, wherein the processing circuitry is further configured to:
provide the offset to enable the scheduling restriction window to be derived based on SSB symbols to be measured, data symbols before and after and the offset.

20. The base station of claim 18, wherein the processing circuitry is further configured to:
receive a report of an SSB radio resource management (RRM) measurement based on an SSB index reading of an intra-frequency cell identification and measurement by the UE in response to at least one of: the target network comprise an ATG target cell or the location of the UE or the propagation delay difference is unknown.

21-24. (canceled)
